(19) United States
(12) Patent Application Publication
(10) Pub. No.: US 2007/0129130 A1
(43) Pub. Date: Jun. 7, 2007

(54) Gaming machine

(75) Inventor: Kazunobu Sato, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/604,875

(22) Filed: Nov. 28, 2006

(30) Foreign Application Priority Data
Nov. 28, 2005 (JP) P2005-342131

(51) Int. Cl. A63F 9/24; G06F 19/00

(52) U.S. Cl. 463/16

(57) ABSTRACT

A gaming machine includes: a display device; an input device; and a processor that is operable to perform a game. The processor is operable with the display device to: (a) display a plurality of first selectable elements, at least two of the first selectable elements being assigned with a selection order that is invisible to a player; (b) allow the player to sequentially select the first selectable elements; (c) allow the player to acquire a privilege if the first selectable elements are selected by the player pursuant to the selection order; and (d) provide an award to the player in accordance with the selected first selectable elements and the privilege acquired by the player.

### CROSS-REFERENCE TO THE RELATED APPLICATION(S)

The present application is based upon and claims priority from prior Japanese Patent Application No. 2005-342131, filed on Nov. 28, 2005, the entire content of which are incorporated herein by reference.

### TECHNICAL FIELD

The present invention relates to a gaming machine such as a slot machine, the gaming machine that provides an interactive bonus game to a player.

### BACKGROUND

Conventionally, a gaming machine has been proposed which has a bonus game in which a bomb is put in one of plural blocks, and when a player selects the block in which the bomb is put, displaying awards, which to be acquired by the player, allocated to neighboring blocks. If a player selects the bomb-loaded block, the player can acquire the total of awards allocated to the neighboring blocks. Such a gaming machine can increase the interest of games because an award a player can acquire can be increased by selecting the bomb-loaded block.

Examples of such gaming machines are disclosed in the documents (1)-(3) listed below.

On the other hand, another gaming machine has been proposed in which a bonus game is caused to proceed in favor of the player by announcing manipulation order of stop switches. Examples of such gaming machines are disclosed in the documents (4) and (5) listed below. In the gaming machine disclosed in the documents (4) and (5), if the player manipulates the stop switches in the announced manipulation order, a particular winning combination of symbols are stopped on an activated line and the player is given an award corresponding to the particular winning combination.

(1) U.S. Pat. No. 6,602,137 B2

(2) U.S. Pat. No. 6,817,944 B2

(3) US 2005/0064929 A1

(4) JP-A-2005-278826

(5) JP-A-2004-188097

However, in the conventional gaming machine disclosed in the documents (1)-(3), the award the player acquires in the bonus game is increased when the player selects a privilege-providing block from a plurality of blocks that are all selectable by the player. Thus configured bonus game might cause a player to feel the bonus game to be monotonous when the player plays games continuously for a long time.

The conventional gaming machine disclosed in the documents (4) and (5) also has the problem that a player tends to feel games to be monotonous if the player plays games continuously for a long time, because games themselves are similar to ordinary bonus games though a bonus game is caused to proceed in favor of the player by announcing manipulation order of the stop switches.

### SUMMARY

One of objects of the present invention is to provide a gaming machine capable of increasing the interest of games by providing a new game feature that relates to selecting manipulations by a player.

According to one aspect of the invention, there is provided a gaming machine including: a display device; an input device; and a processor that is operable to perform a game. The processor is operable with the display device to: (a) display a plurality of first selectable elements, at least two of the first selectable elements being assigned with a selection order that is invisible to a player; (b) allow the player to sequentially select the first selectable elements; (c) allow the player to acquire a privilege if the first selectable elements are selected by the player pursuant to the selection order; and (d) provide an award to the player in accordance with the selected first selectable elements and the privilege acquired by the player.

### BRIEF DESCRIPTION OF THE DRAWINGS

In the accompanying drawings:

FIG. 1 is a perspective view showing an appearance of a slot machine as a gaming machine according to an embodiment of the invention;

FIG. 2 shows nine variable display blocks of the slot machine;

FIG. 3 shows eight activated pay lines of the slot machine;

FIG. 4 is a block diagram schematically showing a control system of the slot machine;

FIG. 5 is a block diagram showing a liquid crystal drive circuit of the slot machine;

FIG. 6 shows an array of symbols (video reel) that are displayed variably (scrolled) in the variable display blocks;

FIG. 7 shows a stop display symbol lottery table which is used when a game is performed by using the variable display blocks;

FIG. 8 is an explanatory diagram of an award table showing winning combinations and their awards which is used when a game is performed by using the variable display blocks;

FIG. 9 is a flowchart of an exemplary main process of the slot machine;

FIG. 10 is a flowchart of an exemplary start reception process of the slot machine;

FIG. 11 is a flowchart of an exemplary lottery process of the slot machine;

FIG. 12 is a flowchart of an exemplary primary game process of the slot machine;

FIG. 13 is a flowchart of an exemplary other games process of the slot machine;

FIG. 14 shows an example that a scatter symbol is stop-displayed in three variable display blocks of the slot machine;

FIG. 15 shows an image that is displayed on a lower liquid crystal display when advancement is made to a SHELL CHANCE GAME in the slot machine;

FIG. 16 is a table which is used in determining the contents of each shell in the SHELL CHANCE GAME;

FIG. 17 shows an exemplary image showing the contents of each shell on the lower liquid crystal display in the SHELL CHANCE GAME;

FIG. 18 shows exemplary images which are displayed on an upper liquid crystal display and the lower liquid crystal display when a TREASURE BONUS GAME is performed in the slot machine;

FIG. 19 shows other exemplary images which are displayed on the upper liquid crystal display and the lower liquid crystal display when the TREASURE BONUS GAME is performed in the slot machine;

FIG. 20 shows other exemplary images which are displayed on the upper liquid crystal display and the lower liquid crystal display when the TREASURE BONUS GAME is performed in the slot machine;

FIG. 21 is a flowchart of an exemplary treasure bonus process of the slot machine;

FIG. 22 shows a table which is used in determining the contents of each normal treasure box in the TREASURE BONUS GAME;

FIG. 23 shows a table which is used in determining selection order of normal treasure boxes in the TREASURE BONUS GAME;

FIG. 24 shows a table which is used in determining the contents of each special treasure box in the TREASURE BONUS GAME;

FIG. 25 shows still other exemplary images which are displayed on the upper liquid crystal display and the lower liquid crystal display when the-TREASURE BONUS GAME is performed in the slot machine; and

FIG. 26 shows further exemplary images which are displayed on the upper liquid crystal display and the lower liquid crystal display when the TREASURE BONUS GAME is performed in the slot machine.

### DETAILED DESCRIPTION

A slot machine according to an embodiment of the present invention will be hereinafter described in detail with reference to the drawings.

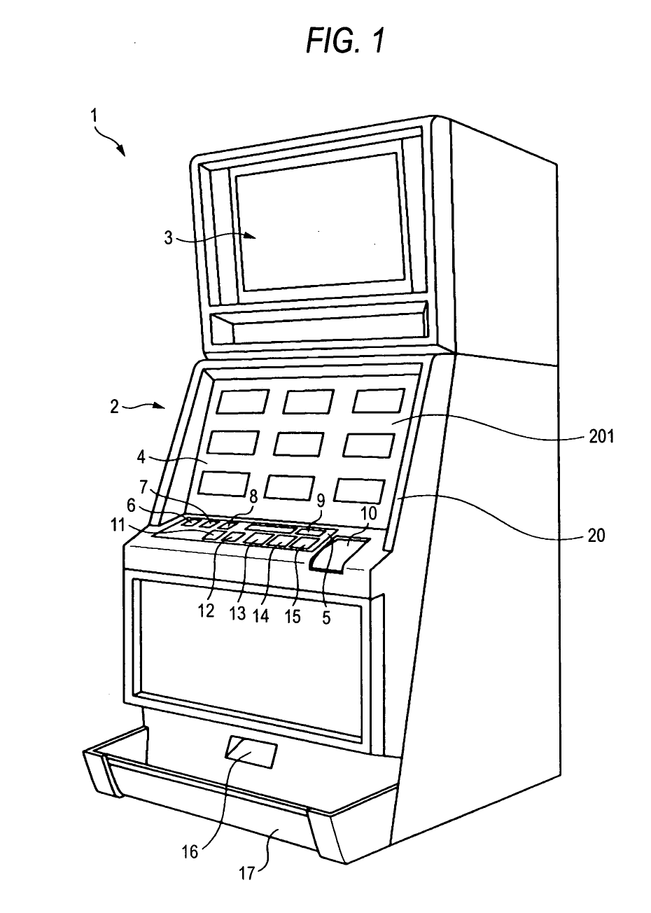

FIG. 1 is a perspective view showing an appearance of a slot machine a. As shown in FIG. 1, the slot machine 1 has a cabinet 2 as a framework of the entire slot machine 1. An upper liquid crystal display 3 occupies a front-top portion of the cabinet 2, and a lower liquid crystal display 4 occupies a front-middle portion of the cabinet 2 so as to be placed inside an apparatus front panel 20. The upper liquid crystal display 3 and the lower liquid crystal display 4 are general-purpose liquid crystal displays, and a transparent touch panel 201 is placed on the front surface of the lower liquid crystal display 4. The upper liquid crystal display 3 and the lower liquid crystal display 4 serve as a display device.

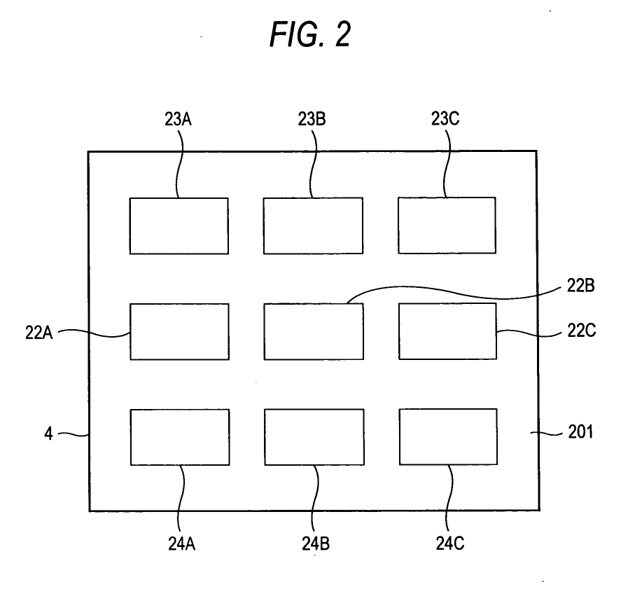

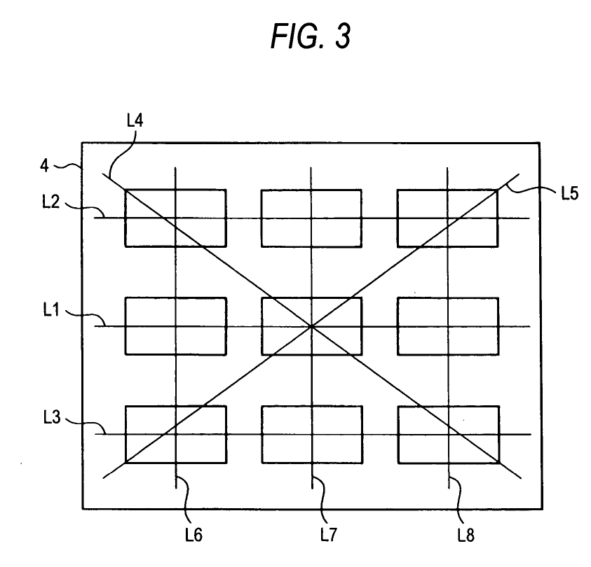

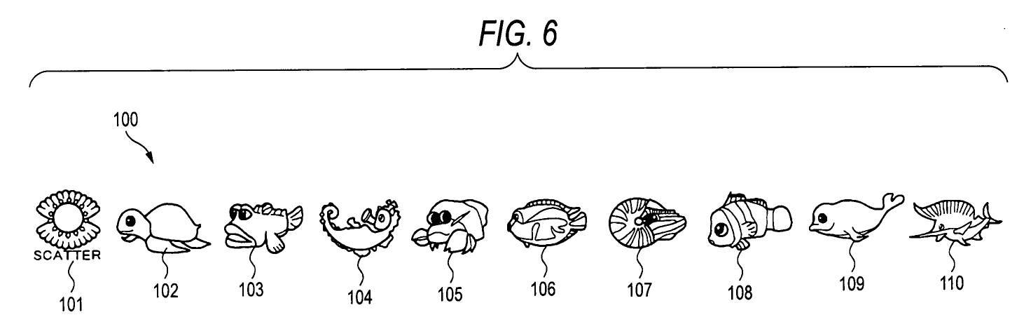

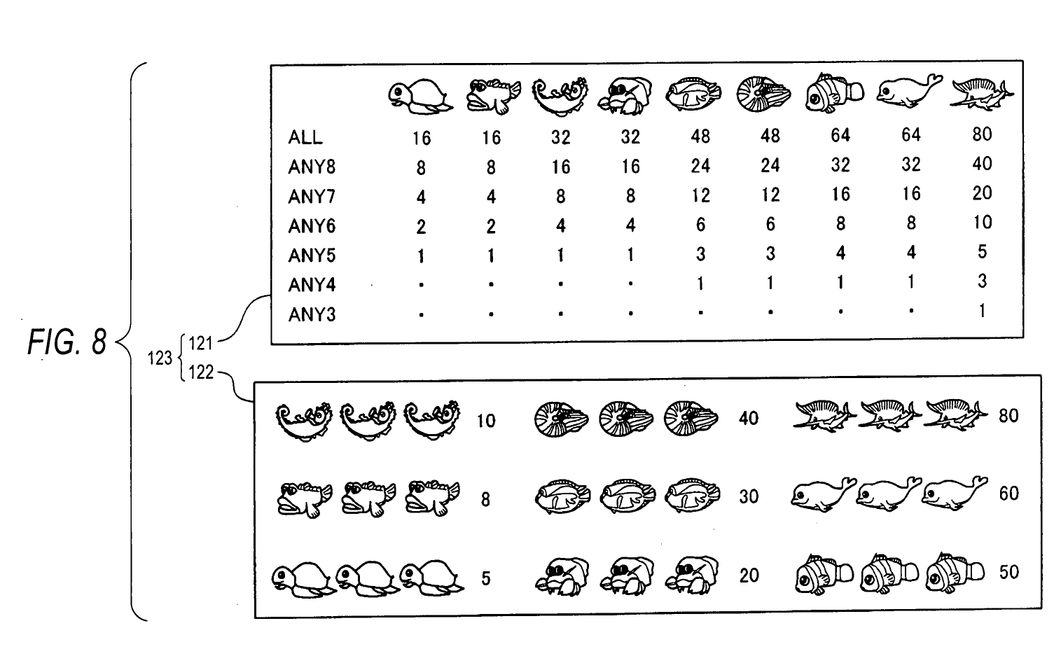

Pieces of information relating to a game such as a gaming method, an award table 123 (see FIG. 8 (referred to later)) showing kinds of winning combinations and their awards, and various kinds of representation which relate to a game are displayed on the upper liquid crystal display 3. As shown in FIG. 2, nine variable display blocks 22A-22C, 23A-23C, and 24A-24C are displayed on the lower liquid crystal display 4. As shown in FIG. 3, eight activated pay lines L1-L8 at the maximum are displayed on the lower liquid crystal display 4. Symbols constituting a video reel 100 (see FIG. 6 (referred to later)) are variably displayed in each of the variable display blocks 22A-22C, 23A-23C, and 24A-24C so as to be scrolled leftward.

A manipulation table 5 is disposed below the lower liquid crystal display 4 so as to project to the front side. A CHANGE button 6, a CASHOUT button 7, and a HELP button 8 are arranged in this order rightward on the manipulation table 5. A coin insertion slot 9 and a bill insertion slot 10 are provided on the right of the HELP button 8. Furthermore, a 1-bet button 11, a SPIN/REPEATBET button 12, a 3-BET button 13, a 5-BET button 14, and an 8-BET button 15 are arranged in this order rightward on a front portion of the manipulation table 5.

The CHANGE button 6 is a button which is pressed in changing a bill that is inserted through the bill insertion slot 10. The CASHOUT button 7 is a button which is pressed when a game has finished. When the CASHOUT button 7 is pressed, coins as game medium acquired by the game are paid out to a coin receiving tray 17 through a coin payout opening 16. The HELP button 8 is a button which is pressed when a game manipulation method, for example, is unknown. When the HELP button 8 is pressed, a proper one of various kinds of help information is displayed on the upper liquid crystal display 3.

A coin sensor 65 (described later), which is disposed adjacent to the coin insertion slot 9, detects an inserted coin. A bill sensor 66 (described later), which is disposed adjacent to the bill insertion slot 10, detects an inserted bill. The 1-BET button 11 is a button which effects one bet each time it is pressed. The SPIN/REPEATBET button 12 is a button for starting variable display of the symbols on the variable display blocks 22A-22C, 23A-23C, and 24A-24C of the lower liquid crystal display 4 with a current number of bets or a previous number of bets when pressed. The numbers of possible bets that can be effected by pressing the SPIN/REPEATBET button 12 are 1, 2, 3, 4, 5, and 8.

The 3-BET button 13 is a button for starting a game with three bets when pressed. The 5-BET button 14 is a button for starting a game with five bets when pressed. The 8-BET button 15 is a button for starting a game with eight bets when pressed. The cabinet 2 is formed with the coin payout opening 16 at a bottom position, and the coin receiving tray 16 for receiving coins paid through the coin payout opening 16 is provided at the bottom of the cabinet 2.

As described above, because of the presence of the 1-BET button 11, the SPIN/REPEATBET button 12, the 3-BET button 13, the 5-BET button 14, and the 8-BET button 15, 1, 2, 3, 4, 5, and 8 bets are possible. In this connection, a predetermined one activated pay line is displayed when the number of bets is one. Predetermined two activated pay lines are displayed when the number of bets is two. Predetermined three activated pay lines are displayed when the number of bets is three. Predetermined five activated pay lines are displayed when the number of bets is five. The activated pay lines L1-L8 (i.e., the maximum number of activated pay lines) are displayed when the number of bets is eight.

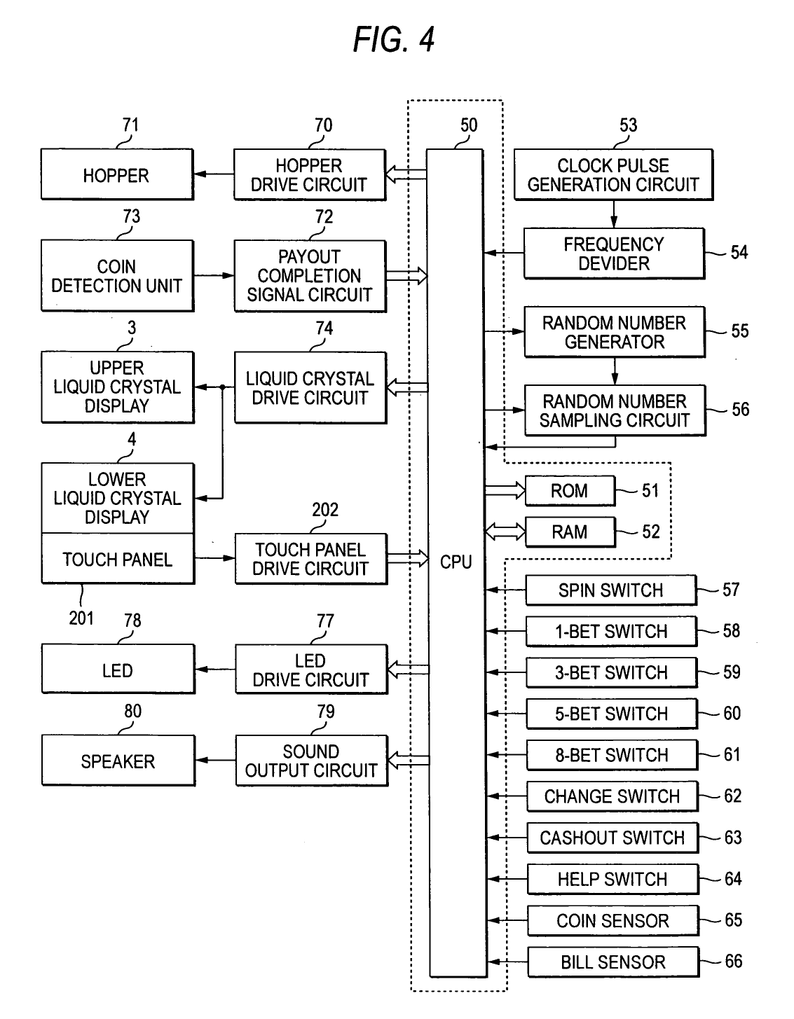

Next, a configuration relating to a control system of the slot machine 1 will be described with reference to FIG. 4. FIG. 4 is a block diagram schematically showing the control system of the slot machine 1.

As shown in FIG. 4, the control system of the slot machine 1 is basically built around a CPU 50 which serves as a controller. A ROM 51 and a RAM 52 are connected to the CPU 50. Various programs, data tables, etc. for execution of processes necessary for controlling the slot machine 1 such as a main process, a start reception process, a lottery process, a base game process, an bonus game process, and a lottery table for determining, by a lottery, stop display symbols of a game (described later) are stored in the ROM 51. The RAM 52 is a memory for temporarily storing various kinds of data as results of computation by the CPU 50.

This embodiment is not limited to the case that the programs, data, etc. that are used for controlling the slot machine 1 are stored in the ROM 51 or the RAM 52 in advance and may be changed when necessary. For example, similar programs, data, etc. may be stored in a recording medium such as a Compact Flash (registered trademark) card and downloaded to the ROM 51 or the like from the recording medium.

A clock pulse generation circuit 53 for generating reference clock pulses and a frequency divider 54 are connected to the CPU 50. A random number generator 55 for generating a random number and a random number sampling circuit 56 are also connected to the CPU 50. A random number that is sampled through the random number sampling circuit 56 is used for various lotteries for determining a winning combination etc. A spin switch 57 which accompanies the SPIN/REPEATBET button 12, a 1-BET switch 58 which accompanies the 1-BET button 11, a 3-BET switch 59 which accompanies the 3-BET button 13, a 5-BET switch 60 which accompanies the 5-BET button 14, an 8-BET switch 61 which accompanies the 8-BET button 15, a CHANGE switch 62 which accompanies the CHANGE button 6, a CASHOUT switch 63 which accompanies the CASHOUT button 7, and a HELP switch 64 which accompanies the HELP button 8 are also connected to the CPU 50. When each button is pressed, the CPU 50 performs a control to perform one of various operations corresponding to the button on the basis of a switch signal that is output from the corresponding switch.

The coin sensor 65 which is disposed adjacent to the coin insertion slot 9 and the bill sensor 66 which is disposed adjacent to the bill insertion slot 10 are also connected to the CPU 50. The coin sensor 65 detects coins that are inserted through the coin insertion slot 9, and the CPU 50 performs computation to determine the number of inserted coins on the basis of coin detection signals that are output from the coin sensor 65. The bill sensor 66 detects a kind/amount of money of a bill that is inserted through the bill insertion slot 10, and the CPU 50 performs computation to determine the number of coins that is equivalent to the amount of money of the bill on the basis of a bill detection signal that is output from the bill sensor 66.

A hopper 71 is connected to the CPU 50 via a hopper drive circuit 70. When a drive signal is output from the CPU 50 to the hopper drive circuit 70, the hopper 71 pays out a predetermined number of coins through the coin payout opening 16. A coin detection unit 73 is connected to the CPU 50 via a payout completion signal circuit 72. The coin detection unit 73 is disposed inside the coin payout opening 16. When detecting that a predetermined number of coins have been paid out through the coin payout opening 16, the coin detection unit 73 outputs, to the payout completion signal circuit 72, a coin payout detection signal, based on which the payout completion signal circuit 72 outputs a payout completion signal to the CPU 50.

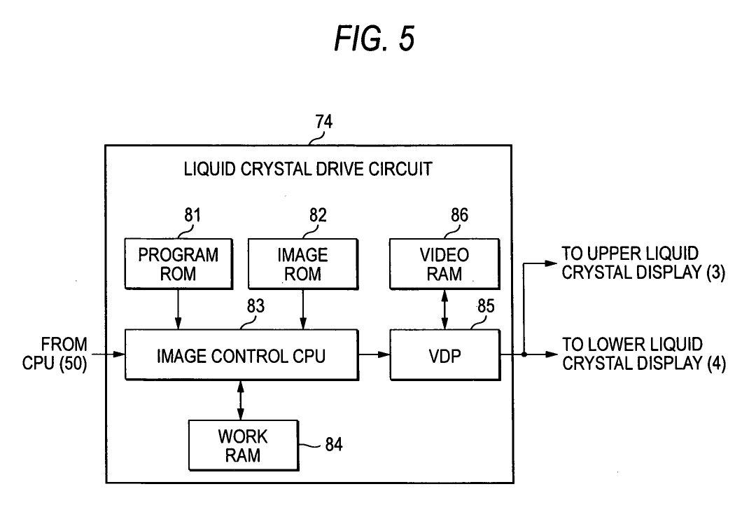

The upper liquid crystal display 3 and the lower liquid crystal display 4 are connected to the CPU 50 via a liquid crystal drive circuit 74, and the CPU 50 controls the upper liquid crystal display 3 and the lower liquid crystal display 4. As shown in FIG. 5, the liquid crystal drive circuit 74 is composed of a program ROM 81, an image ROM 82, an image control CPU 83, a work RAM 84, a VDP (video display processor) 85, a video RAM 86, etc.

An image control program relating to display on the upper liquid crystal display 3 and the lower liquid crystal display 4 and various selection tables are stored in the program ROM 81 shown in FIG. 5. For example, dot data etc. for formation of images such as various images for demonstration representation and a TREASURE BONUS GAME to be displayed on the upper liquid crystal display 3 and the lower liquid crystal display 4, various kinds of help information and award tables to be displayed on the upper liquid crystal display 3, and various symbols of the video reel 100 (see FIG. 6) to be displayed on the lower liquid crystal display 4 are stored in the image ROM 82. The image control CPU 83 determines images to be displayed on the upper liquid crystal display 3 and/or the lower liquid crystal display 4 among the dot data stored in the image Rom 82 in advance according to the image control program stored in the program ROM 81 in advance on the basis of parameters set by the CPU 50. The work RAM 84 is a temporary storage which is used when the image control CPU 83 runs the image control program. The VDP 85 generates image data corresponding to a display content determined by the image control CPU 83 and outputs the generated image data to the upper liquid crystal display 3 and/or the lower liquid crystal display 4. As a result, the various symbols of the video reel 100 (see FIG. 6) are variably displayed or stop-displayed in each of the variable display blocks 22A-22C, 23A-23C, and 24A-24C. The video RAM 86 serves as a temporary storage when the VDP 85 forms an image.

As shown in FIG. 4, the transparent touch panel 201 is connected to the CPU 50 via a touch panel drive circuit 202. Placed on the surface of the lower liquid crystal display 4, the transparent touch panel 201 outputs, via the touch panel drive circuit 202, coordinate information of a position of a touch by a player to allow the CPU 50 to determine the touch position.

In the embodiment, the transparent touch panel 201 and the buttons 11-15 serve as an input device.

LEDs 78 are connected to the CPU 50 via an LED drive circuit 77. A plurality of LEDs 78 are arranged on the front side of the slot machine 1, and are controlled (i.e., turned on/off) by the LED drive circuit 77 on the basis of a drive signal from the CPU 50 in performing various kinds of representation. A sound output circuit 79 and a speaker 80 are also connected to the CPU 50. The speaker 80 produces various sound effects on the basis of an output signal of the sound output circuit 79 in performing various kinds of representation.

Next, the symbols used in games of the slot machine 1 will be described. FIG. 6 shows an array of symbols (video reel) which are variably displayed (scrolled) in each of the variable display blocks 22A-22C, 23A-23C, and 24A-24C of the lower liquid crystal display 4 when a game is performed. As shown in FIG. 6, the symbol array consists of ten symbols that are a scatter 101, a turtle 102, a stonefish 103, a sea horse 104, a hermit crab 105, a boxfish 106, an ammonite 107, a yellow-tailed anemone fish 108, a seal 109, and a marlin 110, which constitute the video reel 100.

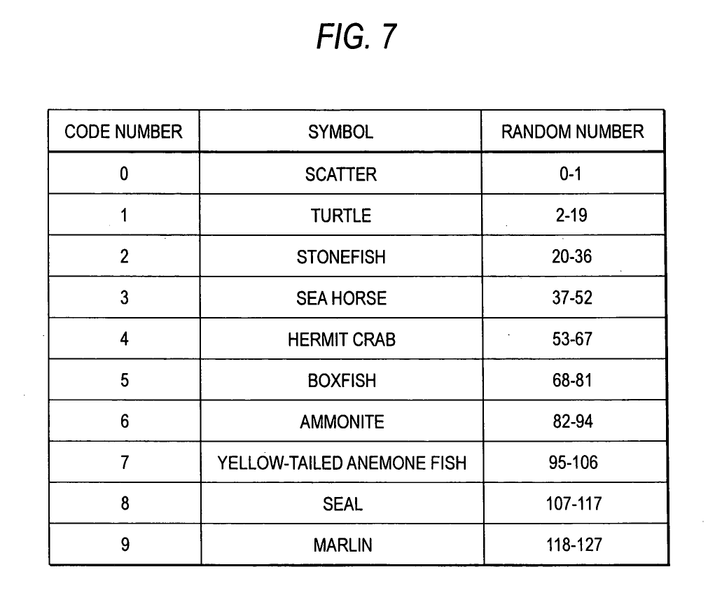

These symbols of the video reel 100 are stop-displayed in each of the nine variable display blocks 22A-22C, 23A-23C, and 24A-24C according to a lottery table shown in FIG. 7. FIG. 7 shows a stop display symbol lottery table which is used when a game is performed by using the nine variable display blocks 22A-22C, 23A-23C, and 24A-24C. The lottery table of FIG. 7 is stored in the ROM 51.

Symbols to be stop-displayed in the respective variable display blocks 22A-22C, 23A-23C, and 24A-24C are determined for the respective variable display blocks 22A-22C, 23A-23C, and 24A-24C. To this end, code numbers “0” to “9” are assigned to the respective symbols of the video reel 100 in left-to-right order in FIG. 6 and the lottery table shown in FIG. 7 is provided. Nine random numbers corresponding to the respective variable display blocks 22A-22C, 23A-23C, and 24A-24C are sampled through the random number sampling circuit 56.

As for the symbols constituting the video reel 100 for the variable display block 23A, as shown in FIG. 7, if a random number sampled through the random number sampling circuit 56 is in a range of “0” to “1,” the symbol of the scatter 101 to which the code number “0” is assigned is stop-displayed in the variable display block 23A. The symbols to which the other code numbers are assigned are likewise stop-displayed according to the lottery table shown in FIG. 7. The symbols constituting the reel 100 for each of the other variable display blocks 22A-22C, 23B-23C, and 24A-24C are handled in the same manner as the symbols constituting the reel 100 for the variable display block 23A.

After the symbols constituting the reel 100 have been variably displayed (scrolled) in each of the variable display blocks 22A-22C, 23A-23C, and 24A-24C, one of those symbols is stop-displayed there. Various combinations of symbols are set in advance as winning combinations (see FIG. 8 (referred to later)). If symbols corresponding to a winning combination are stopped on one of activated pay lines (L1-L8), coins are paid out through the coin payout opening 16 according to the winning combination as in the case of conventional slot machines. Therefore, this feature will not be described any further.

Next, a description will be made of winning combinations and their awards that are used when a game is performed in the slot machine 1 by using the nine variable display blocks 22A-22C, 23A-23C, and 24A-24C. FIG. 8 is an explanatory diagram of an award table showing winning combinations and their awards which are used when a game is performed by using the nine variable display blocks 22A-22C, 23A-23C, and 24A-24C.

The award table 123 shown in FIG. 8 is composed of an ANY-odds award table 121 and a LINE-odds award table 122 and is stored in the ROM 51.

The ANY-odds award table 121 shows, for each symbol, an award corresponding to the number of same symbols that are stop-displayed in the variable display blocks (see FIG. 2) on activated pay lines (see FIG. 3) being displayed on the lower liquid crystal display 4. For example, if the code number of symbols that are stop-displayed in five, on the activated pay lines, of the nine variable display blocks 22A-22C, 23A-23C, and 24A-24C is one of “2” to “19,” a winning combination “ANY-5 of turtle” is established (see FIG. 7). In this case, the turtle 102 is then displayed in each of the five variable display blocks on the activated pay lines (see FIG. 6) and the player acquires an award “1.” Likewise, awards for other kinds of ANY-odds winning combinations are determined according to the ANY-odds award table 121 shown in FIG. 8.

The LINE-odds award table 122 shows, for each symbol, an award corresponding to each activated pay line (displayed on the lower liquid crystal display 4) all the variable display blocks on which have the same symbol being stop-displayed. For example, if the code number of symbols that are stop-displayed in all the variable display blocks on one activated pay line among the nine variable display blocks 22A-22C, 23A-23C, and 24A-24C is one of “2” to “19,” a winning combination “turtle-turtle-turtle” is established for the activated pay line (see FIG. 7). In this case, the turtle 102 is then displayed in all the variable display blocks on the activated pay line concerned and the player acquires an award “5.” If there are plural activated pay lines for which the winning combination “turtle-turtle-turtle” is established, the player acquires an award that is equal to “5” multiplied by the number of these activated pay lines. Likewise, awards for other kinds of LINE-odds winning combinations are determined according to the LINE-odds award table 122 shown in FIG. 8.

If the code numbers of symbols that are stop-displayed in three or more variable display blocks on the activated pay lines being displayed on the lower liquid crystal display 4 among the nine variable display blocks 22A-22C, 23A-23C, and 24A-24C are “0” (i.e., the symbol is the scatter 101) and a SHELL CHANCE GAME is thereafter performed on the lower liquid crystal display 4. The SHELL CHANCE GAME will be described later.

Next, an exemplary operation of the above-configured slot machine 1 will be described.

In the embodiment, the CPU 50 serves as a processor that is operable to perform a game process for providing a game to the player.

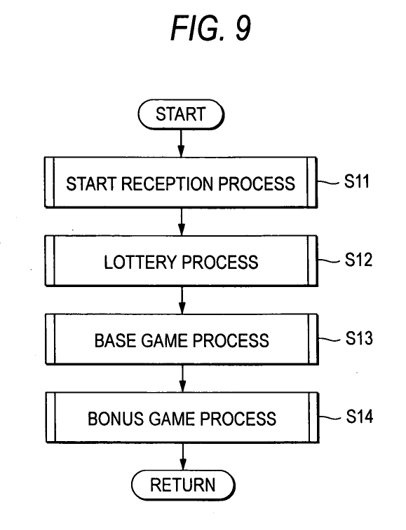

First, an example of a main process which is performed in the slot machine 1 will be described with reference to FIG. 9. FIG. 9 is a flowchart of the exemplary main process. As soon as the slot machine 1 (more specifically, the CPU 50) starts the main process, a start reception process is performed at step S11. The start reception process is a process for receiving a switch signal that is output from the spin switch 57, the 1-BET switch 58, the 3-BET switch 59, the 5-BET switch 60, or the 8-BET switch 61 in response to a manipulation of the SPIN/REPEATBET button 12, the 1-BET button 11, the 3-BET button 13, the 5-BET button 14, or the 8-BET button 15. A game is started upon reception of the switch signal from the switches.

Herein, the CPU 50 is enabling the player to initiate a slot game as a base game by making a bet through the buttons 11-15.

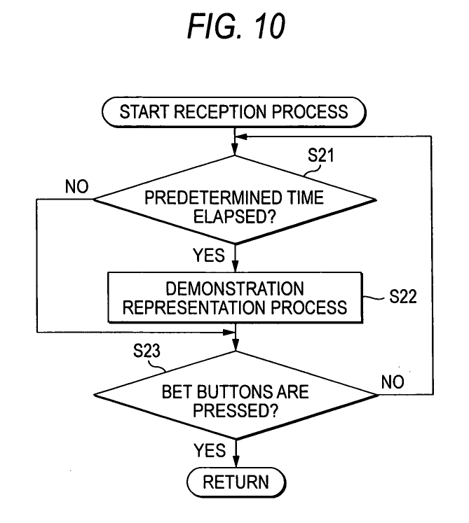

The start reception process which is performed in the slot machine 1 will be described with reference to FIG. 10. FIG. 10 is a flowchart of an exemplary start reception process. At step S11 of the main process shown in FIG. 9, first, at step S21 the CPU 50 determines whether or not a predetermined time (e.g., 15 seconds) has elapsed. When determined that the predetermined time has not elapsed yet (S21: no), the CPU 50 proceeds to step S23 without performing any processing. On the other hand, When determined that the predetermined time has elapsed (S21: yes), the CPU 50 performs, at step S22, a demonstration representation process using the upper liquid crystal display 3 and the lower liquid crystal display 4 and proceeds to step S23. The demonstration representation process is performed according to a predetermined representation pattern.

At step S23, the CPU 50 determines whether or not the SPIN/REPEATBET button 12, the 1-BET button 11, the 3-BET button 13, the 5-BET button 14, or the 8-BET button 15 has been manipulated. When determined that none of the 1-BET button 11 etc. have been manipulated (S23: no), the CPU 50 returns to step S21 and performs the above steps again. On the other hand, When determined that one of the 1-BET button 11 etc. has been manipulated (S23: yes), the CPU 50 interrupts the demonstration representation process even if it is underway, displays predetermined activated pay lines (L1-L8) corresponding to the number of bets on the lower liquid crystal display 4 and displays, for example, the award table 123 which consists of the ANY-odds award table 121 and the LINE-odds award table 122 on the upper liquid crystal display 3. Then, the CPU 50 returns to the main process-shown in FIG. 9 and proceeds to a lottery process (S12) Although in this embodiment predetermined activated pay lines (L1-L8) corresponding to the number of bets are displayed on the lower liquid crystal display 4, a modification is possible in which the activated pay lines L1-L8 (i.e., the maximum number of activated pay lines) are activated by one bet and the award is increased in accordance with the number of bets.

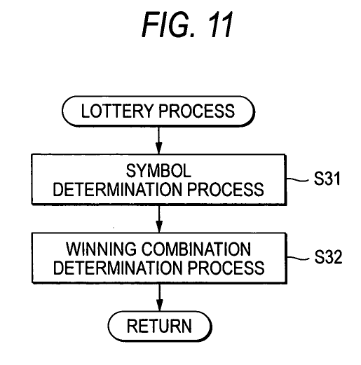

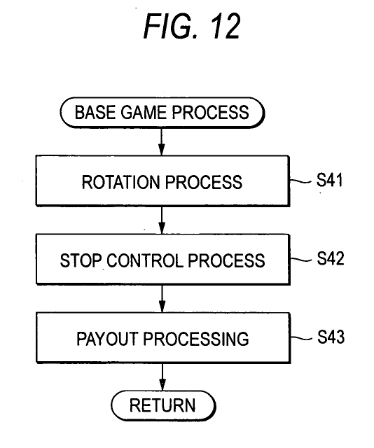

Next, the lottery process (S12) which is performed in the slot machine 1 will be described with reference to FIG. 11. FIG. 11 is a flowchart of an exemplary lottery process. At step S12 of the main process shown in FIG. 9, first, the CPU 50 performs a symbol determination process (S31). In the symbol determination process, symbols to be stop-displayed in the respective variable display blocks 22A-22C, 23A-23C, and 24A-24C in a game (step S42 in FIG. 12 (described later)) are determined for the respective variable display blocks 22A-22C, 23A-23C. More specifically, as described above, nine random numbers are sampled from the range of “0” to “127” by the random number sampling circuit 56 for the respective variable display blocks 22A-22C, 23A-23C and stop display symbols are determined through code numbers according to the lottery table shown in FIG. 7.

When symbols to be stop-displayed in the respective variable display blocks 22A-22C, 23A-23C, and 24A-24C have been determined, a winning combination determination process is performed at step S32. In the winning combination determination process, a winning combination and its award are determined with activated pay lines (L1-L8) that are being displayed on the lower liquid crystal display 4 according to the award table 123 of FIG. 8 which is stored in the ROM 51. After finishing the winning combination determination process (S32), the CPU 50 returns to the main process shown in FIG. 9 and proceeds to a base game process (S13).

Next, the base game process (S13) which is performed in the slot machine 1 will be described with reference to FIG. 12. FIG. 12 is a flowchart of an exemplary base game process. At step S13 of the main process shown in FIG. 9, first, at step S41 the CPU 50 performs a rotation process for scrolling, leftward, the images of the symbols constituting the video reel 100 in each of the variable display blocks 22A-22C, 23A-23C, and 24A-24C in response to a switch signal that was output from the spin switch 57, the 1-BET switch 58, the 3-BET switch 59, the 5-BET switch 60, or the 8-BET switch 61 and received in the start reception process (S11)

At step S42, the CPU 50 stop-displays the image of one of the symbols constituting the reels 100 in each of the variable display blocks 22A-22C, 23A-23C, and 24A-24C according to lottery results of the lottery process (S12), more specifically, the symbol determination process (S31).

At step S43, the CPU 50 performs a payout process in which coins or the like are paid out that correspond to an award that is preset in the award table 123 as corresponding to winning combination symbols that are stop-displayed in (part of) the variable display blocks 22A-22C, 23A-23C, and 24A-24C on activated pay lines (L1-L8) being displayed on the lower liquid crystal display 4. If a winning combination is established on plural ones of the activated pay lines (L1-L8), awards of those winning combinations are summed up. After finishing the payout process (S43), the CPU 50 returns to the main process shown in FIG. 9 and proceeds to a bonus game process (S14).

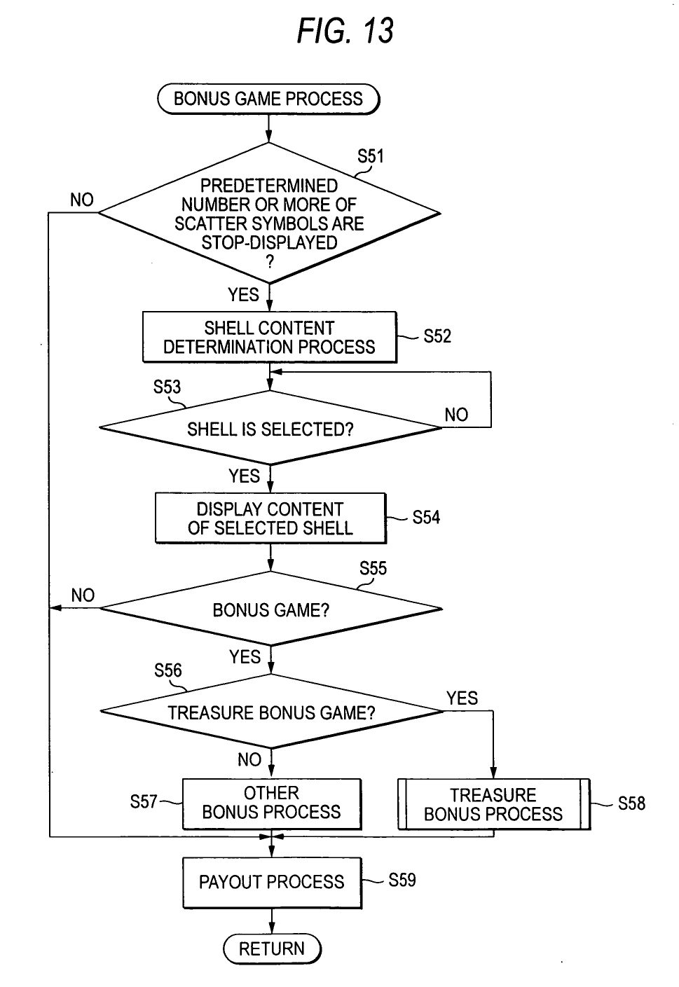

Next, the bonus game process (S14) which is performed in the slot machine 1 will be described with reference to FIG. 13. FIG. 13 is a flowchart of an exemplary bonus game process. At step S14 of the main process shown in FIG. 9, first, at step S51 the CPU 50 determines whether or not a predetermined number or more of symbols of the scatter 101 are stop-displayed in (part of) the variable display blocks 22A-22C, 23A-23C, and 24A-24C on the activated pay lines (L1-L8) being displayed on the lower liquid crystal display 4. In this embodiment, it is assumed that the predetermined number is three.

When determined that the predetermined number or more of symbols of the scatter 101 are not stop-displayed (S51: no), the CPU 50 proceeds to step S59 (payout process; described later) On the other hand, When determined that the predetermined number or more of symbols of the scatter 101 are stop-displayed (S51: yes), the CPU 50 performs a SHELL CHANCE GAME using the lower liquid crystal display 4.

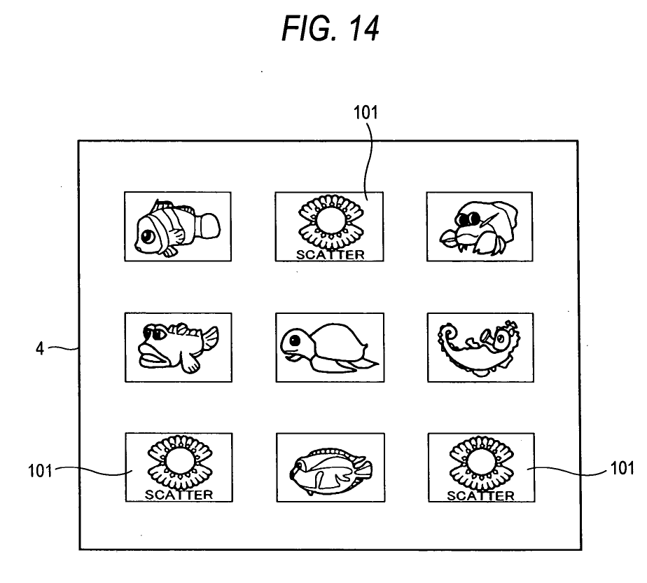

The details of the SHELL CHANCE GAME will be described below. FIG. 14 shows an example that the symbol of the scatter 101 is stop-displayed in three variable display blocks of the lower liquid crystal display 4. In this embodiment, advancement to a SHELL CHANCE GAME is possible when at least three activated pay lines are displayed on the lower liquid crystal display 4.

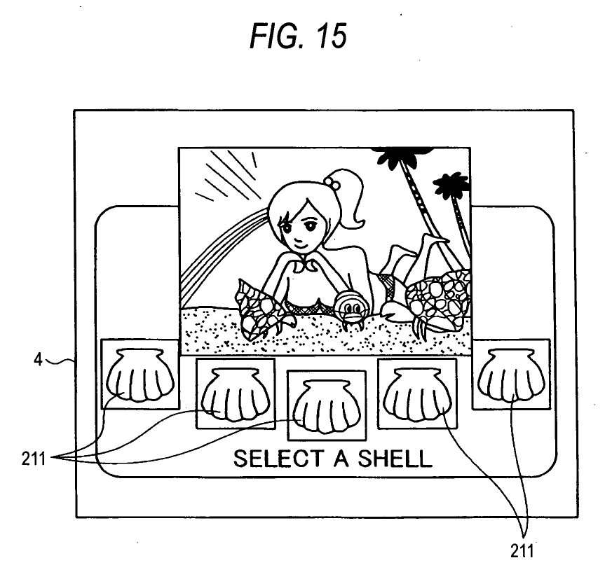

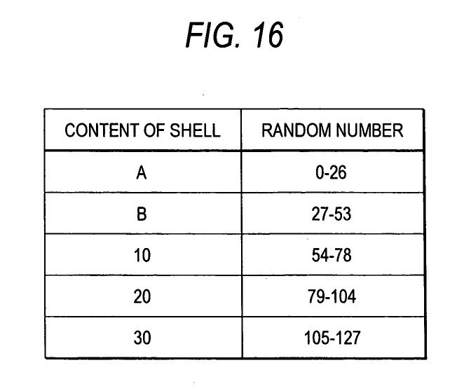

When the process proceeds to a SHELL CHANCE GAME, five shells 211 are displayed on the lower liquid crystal display 4 as shown in FIG. 15. The five shells 211 contain one of “A,” “B,” “10,” “20,” and “30.” In this embodiment, the content of each shell 211 are determined by performing a lottery according to a table shown in FIG. 16 using a random number that is sampled from a range of “0” to “127” through the random number sampling circuit 56.

According to the table shown in FIG. 16, “A” is selected as the content of a shell 211 concerned if a random number that is sampled through the random number sampling circuit 56 is one of “0” to “26.” Character “B” is selected as the content of a shell 211 concerned if a random number is one of “27” to “53.” Numeral “10” is selected as the content of a shell 211 concerned if a random number is one of “54” to “78.” Numeral “20” is selected as the content of a shell 211 concerned if a random number is one of “79” to “104.” Furthermore, “30” is selected as the content of a shell 211 concerned if a random number is one of “105” to “127.”

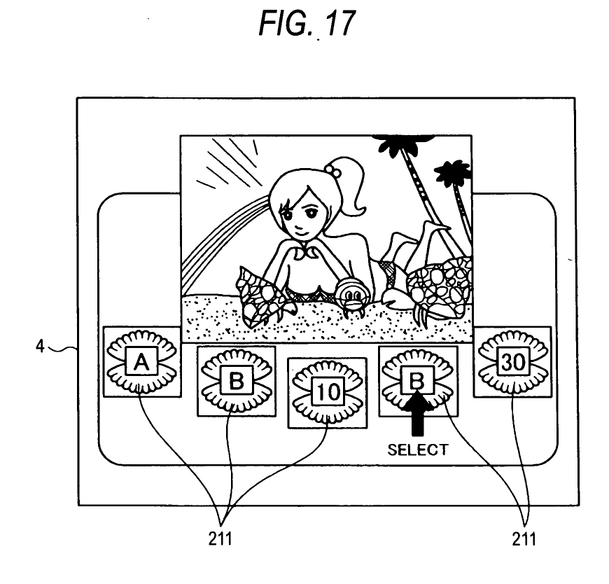

When the player selects one of the five shells 211 being displayed on the lower liquid crystal display 4 by touching the transparent touch panel 20, the content (“A”, “B,” “10,” “20,” or “30”) of the five shells 211 are displayed on the lower liquid crystal display 4 as shown in FIG. 17. At this time, the content of every shell 211 and an arrow clearly indicating the shell 211 selected by the player are displayed on the lower liquid crystal display 4.

The CPU 50 proceeds the process to a TREASURE BONUS GAME if the content of the shell 211 selected by the player is “A.”

The details of the TREASURE BONUS GAME will be described later. If the content of the shell 211 selected by the player are “B,” the process can proceeds to another bonus game, a description of which will be omitted. If the content of the shell 211 selected by the player are “10,” the player can acquire an award “10.” Likewise, if the content of the shell 211 selected by the player are “20” or “30,” the player can acquire an award “20” or “30.”

In this embodiment, it is preferable that to secure a state that the player can select a TREASURE BONUS GAME and another bonus game the content of the five shells 211 being displayed on the lower liquid crystal display 4 be determined so as to necessarily include “A” and “B.”

After the process of determining the content of the shells 211 in the SHELL CHANCE GAME was performed at step S52, it is determined at step S53 whether or not one of the five shells 211 being displayed on the lower liquid crystal display 4 has been selected by the player. This determination processing is performed repeatedly until one of the shells 211 is selected by the player. The content of a selected shell 211 are displayed at step S54, and it is determined at step S55 whether or not the content of the selected shell 211 correspond to a bonus game.

In the determination at step S55, it is determined that the content of the shell 211 selected by the player correspond to a bonus game-if the content are “A” or “B” and it:is determined that the content do not correspond to a bonus game if the content are “10,” “20,” or “30.” If it is determined that the content of the shell 211 selected by the player do not correspond to a bonus game (S55: no), the CPU 50 proceeds to step S59 (payout process; described later). On the other hand, if it is determined that the content of the shell 211 selected by the player correspond to a bonus game (S55: yes), the CPU 50 proceeds to step S56.

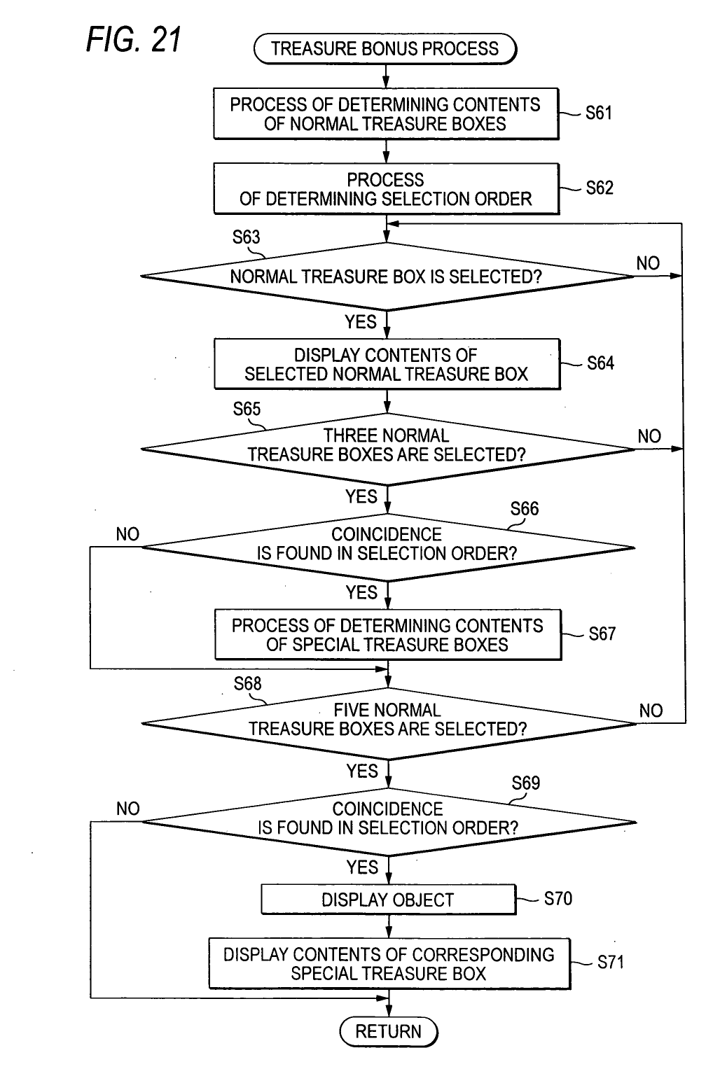

At step S56, the CPU 50 determines whether or not the bonus game is a TREASURE BONUS GAME. In this determination, it is determined that the bonus game is a TREASURE BONUS GAME if the content of the shell 211 selected by the player is “A” and it is determined that the bonus game is not a TREASURE BONUS GAME if the content of the shell 211 selected by the player is “B.” If it is determined that the bonus game is not a TREASURE BONUS GAME (S56: no), another bonus process is performed at step S57 and the CPU 50 proceeds the process to step S59. Another bonus game is performed in the bonus game process (bonus process) of step S57, a description of which will be omitted. On the other hand, if it is determined that the bonus game is a TREASURE BONUS GAME (S56: yes), a treasure bonus process shown in FIG. 21 (described later) is performed at step S58 and the CPU 50 proceeds the process to step S59.

The payout process is performed at step S59. In the payout process, if the content of the shell 211 selected by the player is determined to be “10,” “20,” or “30” (S55: no), coins or the like corresponding to an award meant by the determination result (numerical value) are paid out. Coins or the like corresponding to an award that is acquired by the player in the bonus process of step S57 or the treasure bonus process of step S58 are also paid out in this payout process.

When the payout process (S59) has been performed, the current main process of FIG. 9 is finished and a new main process of FIG. 9 is started.

Next, the TREASURE BONUS GAME which is performed in the slot machine 1 will be described. In this embodiment, as a treasure bonus, five games are performed consecutively without a bet of coins or the like. Alternatively, the number of games to be performed consecutively may be determined by a lottery or the like in making a transition to the TREASURE BONUS GAME. For example, in the SHELL CHANCE GAME, a shell 211 may contain not only “A” indicating a TREASURE BONUS GAME but also a numeral that is a lottery result and indicates the number of games to be performed consecutively.

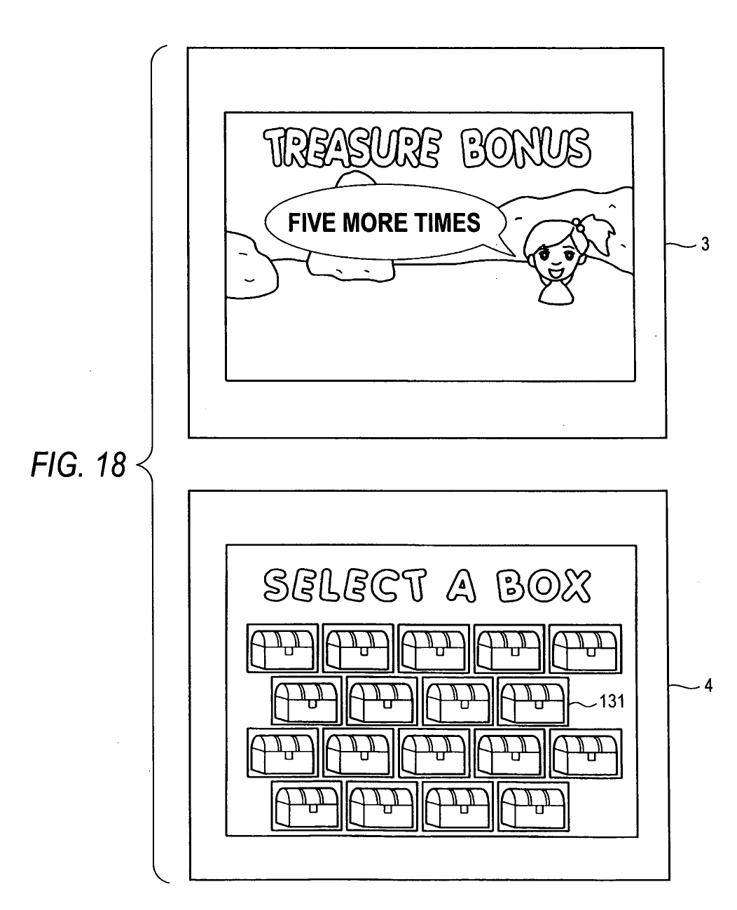

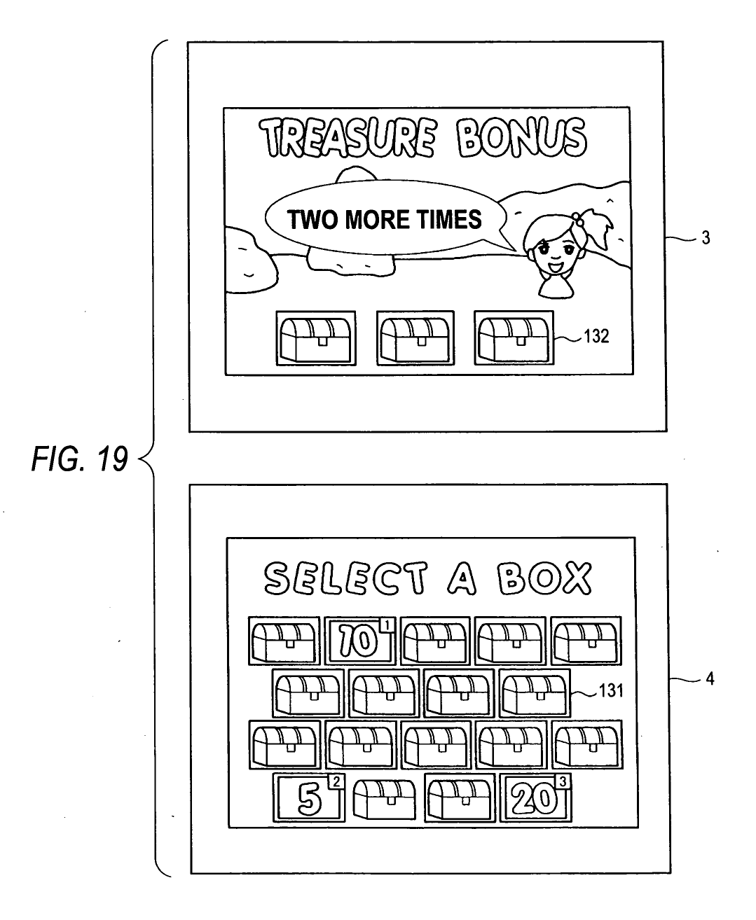

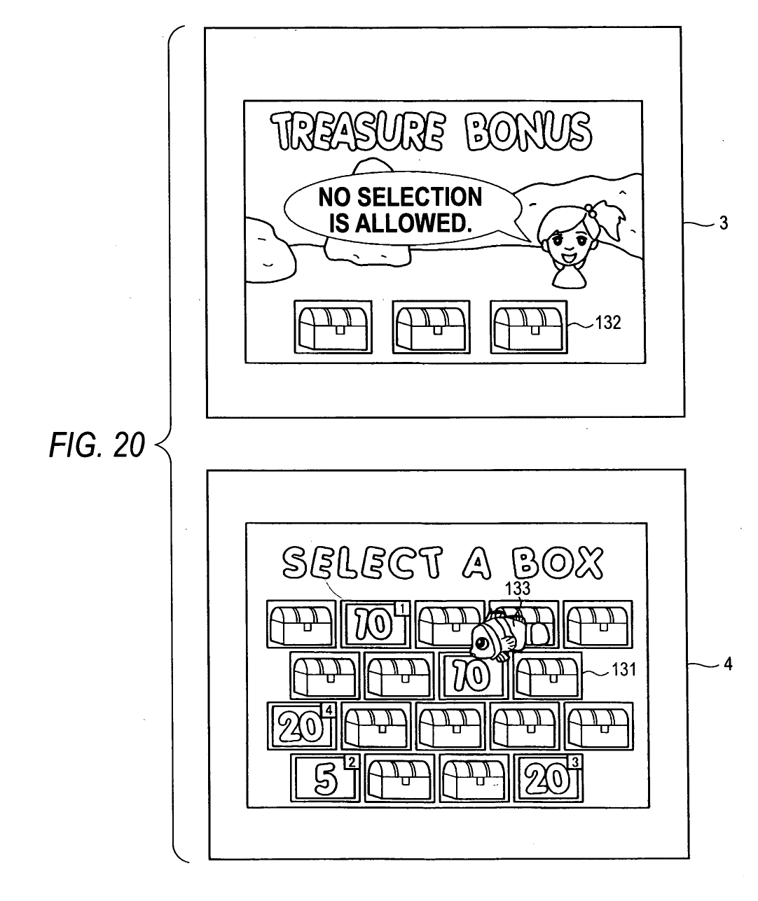

In the TREASURE BONUS GAME, as shown in FIGS. 18-20, a plurality of treasure boxes (hereinafter referred to as “normal treasure boxes”) 131 as first selectable elements from which the player can select are displayed on the lower liquid crystal display 4 and a plurality of treasure boxes (hereinafter referred to as “special treasure boxes”) 132 as second selectable elements from which the player cannot select directly but a selection can be made when a prescribed condition is satisfied are displayed on the upper liquid crystal display 3 (see FIG. 19 or 20).

In this embodiment, as shown in FIG. 19, the special treasure boxes 132 are displayed on the upper liquid crystal display 3 when three normal treasure boxes 131 have been selected in order (hereinafter referred to as “selection order” where appropriate) that is determined by a selection order determination process (described later). Although in this embodiment the special treasure boxes 132 are displayed on the upper liquid crystal display 3 when three normal treasure boxes 131 have been selected in predetermined selection order, the condition of display of the special treasure boxes 132 may be changed as appropriate; the number of normal treasure boxes 131 to be selected may be changed or the special treasure boxes 132 may be displayed from the first.

The content of each of the normal treasure box 131 is information on an award the player can acquire; for example, each normal treasure box 131 contains an award “5,” “10,” “20,” “50,” or “100.”

In the embodiment, the content of each of the normal treasure boxes 131 serves as first award information that indicates an amount of a first payout (such as “5,” “10,” “20,” “50,” or “100”).

On the other hand, the contents of each special treasure box 132 contains information on a certain privilege that increases an award the player can acquire; for example, each special treasure box 132 contains a special award (e.g., “200” or “100”) that is larger than the awards of the normal treasure boxes 131 or information to the effect that an award that has been acquired with a normal treasure box 131 is increased (e.g., “award ×10,” “award ×5,” or “award ×2”). The content of each of the special treasure box 132 may be changed when necessary.

In the embodiment, the special award such as “200” or “100” contained in the special treasure boxes 131 serves as second award information that indicates an amount of a second payout. The special award such as “award ×10,” “award ×5,” or “award ×2,” serves as privilege information that indicates a privilege for increasing the amount of the first payout.

Among the normal treasure boxes 131 shown in FIG. 18, five normal treasure boxes 131 are assigned respective places of selection order that is determined by the selection order determination process (described later). The selection order is determined to allow a player to receive a prescribed privilege when the player has selected normal treasure boxes 131 in the thus-determined selection order. In this embodiment, the prescribed privilege is indicated by the displayed contents of a certain special treasure box 132.

An object 133 capable of causing display of the contents of a special treasure box 132 is assigned to a normal treasure box 131 that is at the last (i.e., fifth) place in the determined selection order (see FIG. 20). Examples of the object 133 are a fish which sails to a certain special treasure box 132 and causes display of its contents and characters that specify a certain special treasure box 132. In the following description, it is assumed that the object 133 is a fish. That is, when the term “object 133” is used solely, it will mean a fish. If normal treasure boxes 131 have been selected to the last (fifth) one in the determined selection order, the object 133 appears and causes display of the contents of a certain special treasure box 132. The special treasure box 132 whose contents are caused to be displayed by the object 133 is determined in advance by a lottery, for example.

By selecting a normal treasure box 131 being displayed on the lower liquid crystal display 4, the player can acquire an award that is assigned to it. If the player succeeds in selecting normal treasure boxes 131 in predetermined selection order, the player can also acquire a privilege that is assigned to a certain special treasure box 132. That is, whereas a privilege of increasing an award the player can acquire is assigned to each special box 132, respective places of predetermined selection order are assigned to the normal treasure boxes 131 and the contents of a special treasure box 132 are displayed when normal treasure boxes 131 are selected in the predetermined selection order. In this manner, the interest of games is increased by providing a new game feature that relates to selecting manipulations by a player.

Next, the treasure bonus process which is performed in the slot machine 1 will be described with reference to FIG. 21. FIG. 21 is a flowchart of the treasure bonus process.

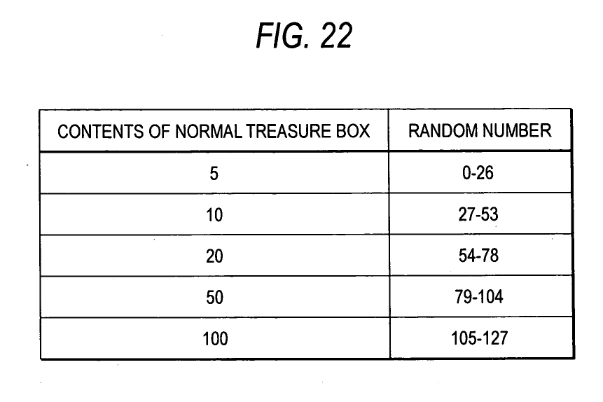

In the treasure bonus process (S58) of the other games process shown in FIG. 13, first, the CPU 50 performs a process of determining the contents of normal treasure boxes 131 (S61). In this process, plural normal treasure boxes 131 are displayed on the lower liquid crystal display 4 (see FIG. 18) and the contents of each normal treasure box 131 are determined by performing a lottery according to a table shown in FIG. 22 using a random number that is sampled from a range of “0” to “127” through the random number sampling circuit 56.

According to the table shown in FIG. 22, “5” is selected as the contents of a normal treasure box 131 concerned if a random number that is sampled through the random number sampling circuit 56 is one of “0” to “26.” Numeral “10” is selected as the contents of a normal treasure box 131 concerned if a random number is one of “27” to “53.” Numeral “20” is selected as the contents of a normal treasure box 131 concerned if a random number is one of “54” to “78.” Numeral “50” is selected as the contents of a normal treasure box 131 concerned if a random number is one of “79” to “104.” Furthermore, “100” is selected as the contents of a normal treasure box 131 concerned if a random number is one of “105” to “127.”

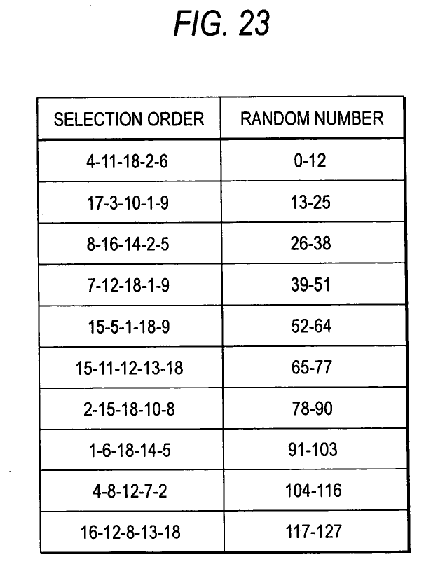

After finishing the process of determining the contents of the normal treasure boxes 131, at step S62 the CPU 50 performs a process (hereinafter referred to as “selection order determination process”) of determining selection order (an item for determining whether to give a privilege) of normal treasure boxes 131. In the selection order determination process, such selection order is determined that as described above the player will be given a privilege if the player selects normal treasure boxes 131 in that order. More specifically, selection order is determined by performing lotteries according to a table shown: in FIG. 23 using a random number that is sampled from a range of “0” to “127” through the random number sampling circuit 56.

According to the table shown in FIG. 23, selection order “4-11-18-2-6” is selected if a random number that is sampled through the random number sampling circuit 56 is one of “0” to “12.” Selection order “17-3-10-1-9” is selected if a random number is one of “13” to “25.” Selection order “8-16-14-2-5” is selected if a random number is one of “26” to “38.” Selection order “7-12-18-1-9” is selected if a random number is one of “39” to “51.” Selection order “15-5-1-18-9” is selected if a random number is one of “52” to “64.” Selection order “15-11-12-13-18” is selected if a random number is one of “65” to “77.” Selection order “2-15-18-10-8” is selected if a random number is one of “78” to “90.” Selection order “1-6-18-14-5” is selected if a random number is one of “91” to “103.” Selection order “4-8-12-7-2” is selected if a random number is one of “104” to “116.” Selection order “16-12-8-13-18” is selected if a random number is one of “117” to “127.” It goes without saying that the pieces of selection order shown in FIG. 23 are just examples and may be changed as appropriate.

After finishing the process of determining selection order, the CPU 50 determines at step S63 whether or not the player has selected one of the plural normal treasure boxes 131 being displayed on the lower liquid crystal display 4. The player can select one of the normal treasure boxes 131 by touching the transparent touch panel 201.

If the player has selected one of the normal treasure boxes 131 (S63: yes), the CPU 50 proceeds the process to step S64, where it displays the contents of the normal treasure box 131 selected by the player on the lower liquid crystal display 4. The determination processing of step S63 is performed repeatedly until one of the normal treasure boxes 131 is selected by the player.

After displaying the content of the selected normal treasure box 131 on the lower liquid crystal display 4, the CPU 50 determines at step S65 whether or not three normal treasure boxes 131 have been selected. If three normal treasure boxes 131 have not been selected yet (S65: no), the CPU 50 returns to step S63 and performs the same steps again. On the other hand, three normal treasure boxes 131 have been selected (S65: yes), the CPU 50 determines at step S66 whether or not the order of selection of the three normal treasure boxes 131 is identical to the selection order that was determined at step S62. This is to determine whether to display a special treasure box 132 on the upper liquid crystal display 3.

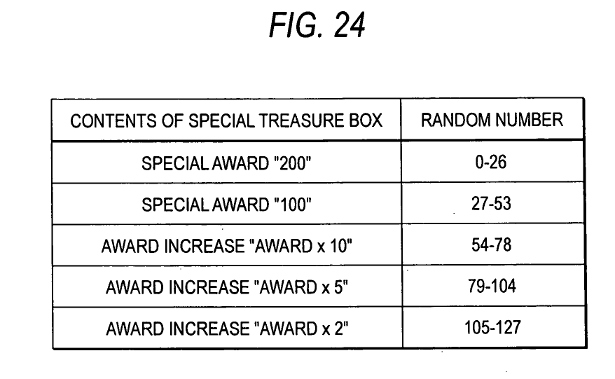

If determining that the order of selection of the three normal treasure boxes 131 is identical to the selection order that was determined at step S62, at step S67 the CPU 50 performs a process of determining the contents of special treasure boxes 132. In this process, plural special treasure boxes 132 are displayed on the upper liquid crystal display 3 (see FIG. 19) and the contents of each special treasure box 132 are determined by performing a lottery according to a table shown in FIG. 24 using a random number that is sampled from a range of “0” to “127” through the random number sampling circuit 56 as in the process of determining the contents of each normal treasure box 131.

According to the table shown in FIG. 24, a special award “200” is selected as the contents of a special treasure box 132 concerned if a random number that is sampled through the random number sampling circuit 56 is one of “0” to “26.” A special award “100” is selected as the contents of a special treasure box 132 concerned if a random number is one of “27” to “53.” Award increase “award ×10” is selected as the contents of a special treasure box 132 concerned if a random number is one of “54” to “78.” Award increase “award ×5” is selected as the contents of a special treasure box 132 concerned if a random number is one of “79” to “104.” Award increase “award ×2” is selected as the contents of a special treasure box 132 concerned if a random number is one of “105” to “127.”

When the process of determining the contents of special treasure boxes 132 has been performed or if it is determined at step S66 that the order of selection of the three normal treasure boxes 131 is not identical to the selection order that was determined at step S62, the CPU 50 determines at step S68 whether or not five normal treasure boxes 131 have been selected. If determining that five normal treasure boxes 131 have not been selected yet (S68: no), the CPU 50 returns to step S63 and performs the same steps again. On the other hand, if determining that five normal treasure boxes 131 have been selected (S68: yes), the CPU 50 determines at step S69 whether or not the order of selection of the five normal treasure boxes 131 is identical to the selection order that was determined at step S62. This is to determine whether to display the contents of a corresponding special treasure box 132 on the upper liquid crystal display 3.

If determining that the order of selection of the five normal treasure boxes 131 is identical to the selection order that was determined at step S62, at step S70 the CPU 50 displays an object 133. At step S71, the CPU 50 displays the contents of a special treasure box 132 corresponding to the object 133. In displaying the contents of the corresponding special treasure box 132, the CPU 50 performs staging of causing the object 133 to sail from the lower liquid crystal display 4 to the corresponding special treasure box 132 being displayed on the upper liquid crystal display 3. After the object 133 reaches the corresponding special treasure box 132, as described above, the CPU 50 displays the contents of the special treasure box 132 on the upper liquid crystal display 3.

When displaying the contents of the special treasure box 132 corresponding to the object 133 or determining at step S69 that the order of selection of the five normal treasure boxes 131 is not identical to the selection order that was determined at step S62, the CPU 50 finishes the treasure bonus process and proceeds to the payout process (S59) of the other games process shown in FIG. 13.

In the payout process (S59), the contents of the selected ones (or the ones the contents of which are displayed) of the normal treasure boxes 131 and the special treasure boxes 132, are considered as the award that is acquired by the player.

Exemplary images which are displayed on the upper liquid crystal display 3 and the lower liquid crystal display 4 when a TREASURE BONUS GAME is performed in the slot machine 1 will be described below with reference to FIGS. 18-20, 25, and 26, which are drawings showing exemplary images that are displayed on the upper liquid crystal display 3 and the lower liquid crystal display 4 when a TREASURE BONUS GAME is performed in the slot machine 1.

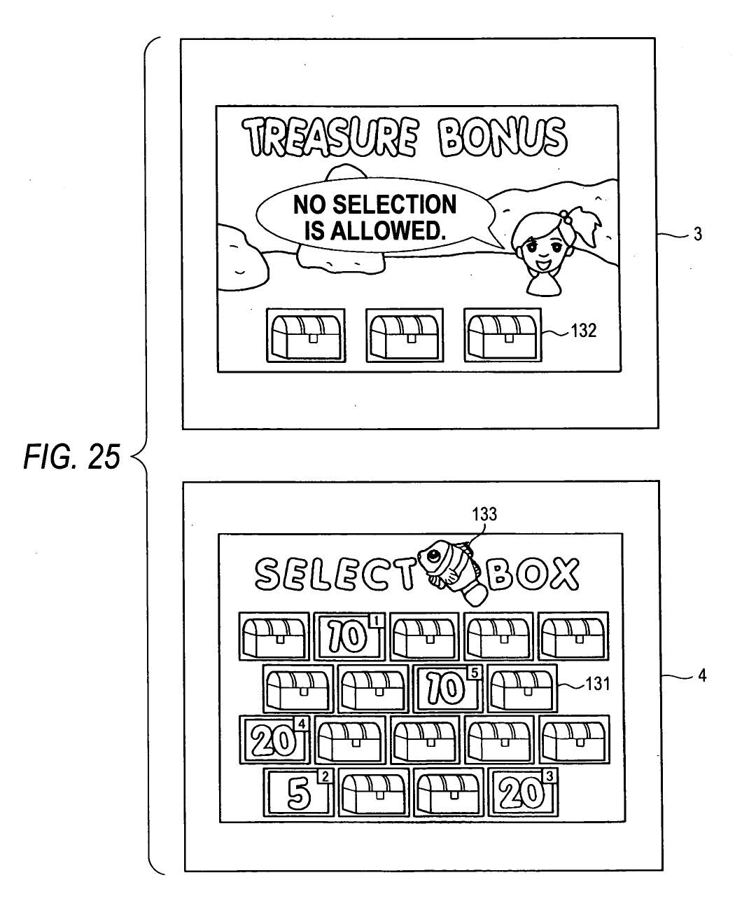

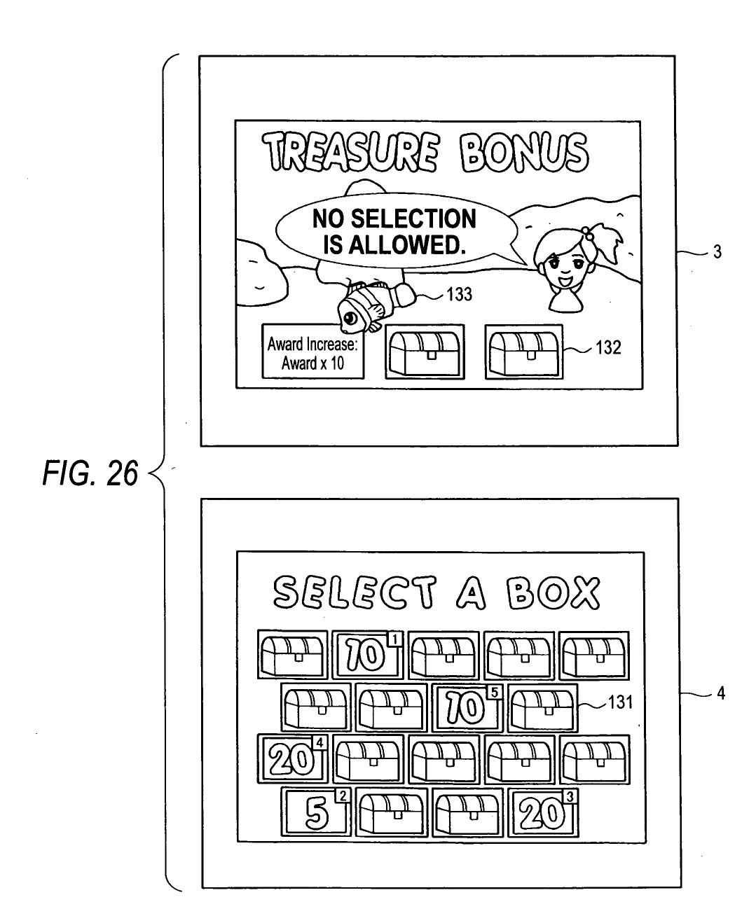

FIG. 18 shows a state that none of the normal treasure boxes 131 have been selected by the player. FIG. 19 shows a state that three normal treasure boxes 131 have been selected. FIG. 20 shows a state that five normal treasure boxes 131 have been selected and an object 133 has appeared. FIGS. 19 and 20 correspond to a case that normal treasure boxes 131 have been selected in the same order as the selection order that was determined at the above-described selection order determination process (S62). FIG. 25 shows a state that the object 133 that thus appeared is moving. FIG. 26 shows a state that the object 133 has reached the corresponding special treasure box 132.

As shown in FIG. 18, in the state that none of the normal treasure boxes 131 have been selected by the player, no special treasure boxes 132 are displayed on the upper liquid crystal display 3. As shown in FIG. 19, in the state that three normal treasure boxes 131 have been selected (a transition has been made from the state of FIG. 18) and the order of selection is identical to the selection order that was determined by the selection order determination process, the special treasure box 132 is displayed on the upper liquid crystal display 3. In this embodiment, if a normal treasure box 131 is selected by the player at the same place in selection order as in the predetermined selection order, the place in selection order is indicated at the top-right corner of the selected normal treasure box 131. This allows the player to intuitively recognize whether or not the player has selected a normal treasure box according to the predetermined selection order.

If two additional normal treasure boxes 131 have been selected (five normal treasure boxes 131 have been selected in total) in the same order as the above-mentioned selection order starting from the state that the special treasure boxes 132 were displayed on the upper liquid crystal display 3 as shown in FIG. 19, as shown in FIG. 20 the contents of the fifth normal treasure box 131 and an object 133 are displayed. At this time, as shown in FIG. 20, the object 133 is displayed near the fifth normal treasure box 131.

The object 133 that has appeared on the lower liquid crystal display 4 is correlated with a special treasure box 132 in advance. After a while, as shown in FIG. 25, the object 133 that appeared on the lower liquid crystal display 4 starts to sail from the fifthly selected normal treasure box 131 toward the corresponding special treasure box 132. Then, as shown in FIG. 26, the object 133 jumps from the lower liquid crystal display 4 to the upper liquid crystal display 3, reaches the corresponding special treasure box 132, and causes the contents of the special treasure box 132 to be displayed.

The example of FIGS. 18-20, 25, and 26 corresponds to a case that “10,” “5,” “20,” “20,” and “10 ” are acquired as awards of the selected ordinary boxes 131 and a privilege of increasing an award (award increase; more specifically, information to the effect that an award is multiplied by 10 (“award ×10”)) is displayed as the contents of the special treasure box 132 to which the object 133 reaches. In this case, the total award “65” of the selected normal treasure boxes 131 is multiplied by 10 because of the privilege of the special treasure box 132 and hence the player can acquire an award “650.”

As described above, in the slot machine 1 according to the embodiment, an additional privilege is acquired by a player when the player has selected normal treasure boxes 131 in selection order that is an item for determining whether to give a privilege and is assigned to those normal treasure boxes 131. This makes it possible to provide a new game feature that relates to selecting manipulations by the player, which in turn makes it possible to increase the interest of games.

In particular, in the above-described slot machine 1, special treasure boxes 132 from which a selection can be made when a prescribed condition is satisfied is selected are displayed on the upper liquid crystal display 3 and a privilege (the above-mentioned additional privilege) is given to the player in accordance with information that is correlated with a selected special treasure box 132. This makes it possible to give a privilege (the above-mentioned additional privilege) in accordance with information that is correlated with a special treasure box 132 a player cannot select directly, which in turn makes it possible to enhance the expectation of the player and to thereby increase the interest of games further.

More specifically, a special treasure box 132 is selected when a player has selected normal treasure boxes 131 in the above-mentioned selection order, and a privilege is given to the player in accordance with information that is correlated with the special treasure box 132. This makes it possible to cause a player to be interested in selection order in selecting normal treasure boxes 131 and to thereby let the player focused on the game.

In particular, in the above-described slot machine 1, a special treasure box 132 is specified by an object 133 which appears in response to manipulations of selecting normal treasure boxes 131 in the above-mentioned selection order. This makes it possible to attract interest of a player in the object 133 and to thereby let the player focused on the game. Since the object 133 moves to the special treasure box 132 to be specified, it is possible to keep the player interested in the object 133 until it reaches the special treasure box 132.

In the above-described slot machine 1, the special treasure boxes 132 are displayed on the upper liquid crystal display 3 when a player has selected a prescribed number of normal treasure boxes 131 by a player in the above-mentioned selection order. Since the special treasure boxes 132 are displayed only in the case where the prescribed number of normal treasure boxes 131 have been selected in the above-mentioned selection order, the expectation that the player would have when the special treasure boxes 132 are displayed can be enhanced further.

In the above-described slot machine 1, the normal treasure boxes 131 are displayed on the lower liquid crystal display 4 and the special treasure boxes 132 are displayed on the upper liquid crystal display 3. Displaying the special treasure boxes 132 on the different display than the normal treasure boxes 131 are displayed amplifies the sense of accomplishment that a player would feel when the player has succeeded in selecting a special treasure box 132, which makes it possible to increase the interest of games further.

Furthermore, in the above-described slot machine 1, whereas award information is correlated with each normal treasure box 131, award information or privilege information relating to award information of particular normal treasure boxes 131 is correlated with each special treasure box 132. For example, information on a privilege of increasing an award is employed as the privilege information relating to award information of particular normal treasure boxes 131. This makes it possible to attract interest of a player and to thereby increase the interest of games further.

The present invention is not limited to the above embodiment and various modifications are possible without departing from the spirit and scope of the invention. The sizes, shapes, etc. shown in the accompanying drawings for the embodiment should not be construed as limiting the invention and can be modified as appropriate within such ranges that the advantages of the invention are maintained. In other respects, the embodiment can be practiced in such a manner as to be modified as appropriate without departing from the range of the object of the invention. Exemplary modifications of the embodiment will be described below.

In the above-described slot machine 1, a special treasure box 132 is selected by an object 133 which appears in response to manipulations of selecting normal treasure boxes 131 in the above-mentioned selection order. However, the method for selecting a special treasure box 132 maybe changed as appropriate. For example, a player may be allowed to select a special treasure box 132 if the player has selected normal treasure boxes 131 in the above-mentioned selection order. In the case of this modification, a player is allowed to select a special treasure box 132 if the player has selected normal treasure boxes 131 in the above-mentioned selection order and a privilege is given to the player in accordance with information that is correlated with a selected special treasure box 132. This makes it possible to cause a player to be interested in selection order in selecting normal treasure boxes 131 and to feel a sense of accomplishment because the player can resultingly select a special treasure box 132 he or she cannot select directly. As a result, this modification makes it possible to cause a player to be focused on the game and to thereby increase the interest of games further.

Although in the above embodiment the coin is used as an exemplary gaming medium, the gaming medium is not limited to the coin and may be of any form as long as playing with the slot machine 1 is enabled. In particular, when a player is paid game medium that are acquired by a game, the player may receive a magnetic card on which the number or amount of game medium is recorded or a receipt on which the number or amount of game medium is printed. Furthermore, the number or amount of game medium to be paid out may be managed by a server which performs information management for the slot machine 1.

In the slot machine 1 according to the embodiment, a lottery (performed in the lottery process, for example) is performed according to a lottery table which describes a relationship between random numbers and symbols, for example. However, the manner of a lottery is not limited to the above and may be modified as appropriate.

In the present invention, an additional privilege is acquired by a player when the player has selected first selectable elements in selection order that is an item for determining whether to give a privilege and is assigned to first selectable elements which the player can select. A new game feature that relates to selecting manipulations by a player is thereby provided, whereby the interest of games is increased. As such, the invention has sufficient industrial applicability.

What is claimed is:

1. A gaming machine comprising:
a display device;
an input device; and
a processor that is operable to perform a game, the processor being operable with the display device to:
(a) display a plurality of first selectable elements, at least two of the first selectable elements being assigned with a selection order that is invisible to a player;
(b) allow the player to sequentially select the first selectable elements;
(c) allow the player to acquire a privilege if the first selectable elements are selected by the player pursuant to the selection order; and
(d) provide an award to the player in accordance with the selected first selectable elements and the privilege acquired by the player.

2. The gaming machine according to claim 1, wherein when allowing the player to acquire the privilege, the processor is operable to display a second selectable element that includes the privilege.

3. The gaming machine according to claim 2, wherein the processor selects the second selectable element for allowing the player to acquire the privilege.

4. The gaming machine according to claim 3, wherein the processor is operable to display an image of an object selecting the second selectable element.

5. The gaming machine according to claim 3, wherein the processor allows the player to select the second selectable element through the input device.

6. The gaming machine according to claim 2, wherein the processor is operable to display the second selectable element, if predetermined numbers of the first selectable elements are is sequentially selected by the player pursuant to the selection order.

7. The gaming machine according to claim 2, wherein the display device comprises:
a first display device that displays the first selectable elements; and
a second display device that is provided separately from the first display device, and displays the second selectable element.

8. The gaming machine according to claim 2, wherein each of the first selectable elements is correlated with first award information that indicates an amount of a first payout, and
wherein the second selectable element is correlated with one of:
second award information that indicates an amount of a second payout; and
privilege information that indicates the privilege for increasing the amount of the first payout.

9. The gaming machine according to claim 2, wherein the processor is operable to display a plurality of the second selectable elements.

10. The gaming machine according to claim 1, wherein the processor is operable to:
enable the player to initiate a slot game as a base game by making a bet through the input device;
perform variable display of reels on which a plurality of symbols are arranged; and
provide an award to the player in accordance with a combination of the symbols being displayed stopped after the variable display.

11. A gaming machine comprising:
a display device;
an input device; and
a processor that is operable to perform a game, the processor being operable with the display device to:
(a) display a plurality of first selectable elements, at least two of the first selectable elements being assigned with a selection order that is invisible to a player;
(b) allow the player to sequentially select the first selectable elements;
(c) display a second selectable element that includes a privilege to be acquired by the player, if the first selectable elements are selected by the player pursuant to the selection order; and
(d) provide an award to the player in accordance with the selected first selectable elements and the privilege acquired by the player.

12. The gaming machine according to claim 11, wherein the processor selects the second selectable element for allowing the player to acquire the privilege.

13. The gaming machine according to claim 12, wherein the processor is operable to display an image of an object selecting the second selectable element.

14. The gaming machine according to claim 12, wherein the processor allows the player to select the second selectable element through the input device.

15. The gaming machine according to claim 11, wherein the processor is operable to display the second selectable element, if predetermined numbers of the first selectable elements are sequentially selected by the player pursuant to the selection order.

16. The gaming machine according to claim 11, wherein the display device comprises:
a first display device that displays the first selectable elements; and
a second display device that is provided separately from the first display device, and displays the second selectable element.

17. The gaming machine according to claim 11, wherein each of the first selectable elements is correlated with first award information that indicates an amount of a first payout, and
wherein the second selectable element is correlated with one of:
second award information that indicates an amount of a second payout; and
privilege information that indicates the privilege for increasing the amount of the first payout.

18. The gaming machine according to claim 11, wherein the processor is operable to display a plurality of the second selectable elements.

19. The gaming machine according to claim 11, wherein the processor is operable to:
enable the player to initiate a slot game as a base game by making a bet through the input device;
perform variable display of reels on which a plurality of symbols are arranged; and
provide an award to the player in accordance with a combination of the symbols being displayed stopped after the variable display.

20. A gaming machine comprising:
a display device;
an input device; and
a processor that is operable to perform a base game and a bonus game, the processor being operable with the display device to:
(a) enable a player to initiate the base game by making a bet through the input device;
(b) perform variable display of reels on which a plurality of symbols are arranged;
(c) provide a base game award to the player in accordance with a combination of the symbols being displayed stopped after the variable display; and
(d) determine whether to proceed to the bonus game in accordance with the combination of the symbols, and
(e) display a plurality of first selectable elements in the bonus game, at least two of the first selectable elements being assigned with a selection order that is invisible to the player;
(f) allow the player to sequentially select the first selectable elements;
(g) display a second selectable element that includes a privilege to be acquired by the player, if the first selectable elements are selected by the player pursuant to-the selection order; and
(h) provide an award to the player in accordance with the selected first selectable elements and the privilege acquired by the player.

21. The gaming machine according to claim 20, wherein the processor selects the second selectable element for allowing the player to acquire the privilege.

22. The gaming machine according to claim 21, wherein the processor is operable to display an image of an object selecting the second selectable element.

23. The gaming machine according to claim 21, wherein the processor allows the player to select the second selectable element through the input device.

24. The gaming machine according to claim 20, wherein the processor is operable to display the second selectable element, if predetermined numbers of the first selectable elements are sequentially selected by the player pursuant to the selection order.

25. The gaming machine according to claim 20, wherein the display device comprises:
a first display device that displays the first selectable elements; and
a second display device that is provided separately from the first display device, and displays the second selectable element.

26. The gaming machine according to claim 20, wherein each of the first selectable elements is correlated with first award information that indicates an amount of a first payout, and
wherein the second selectable element is correlated with one of:
second award information that indicates an amount of a second payout; and
privilege information that indicates the privilege for increasing the amount of the first payout.

27. The gaming machine according to claim 20, wherein the processor is operable to display a plurality of the second selectable elements.
